(19) United States
(12) Patent Application Publication
(10) Pub. No.: US 2003/0228854 A1
(43) Pub. Date: Dec. 11, 2003

(54) Method and system for increasing the output power of a wireless signal

(75) Inventors: Russell Morris, Keller, TX (US); Heikki Heliste, Irving, TX (US); Mika Hirvilampi, Lewisville, TX (US); Eero Valitalo, Coppell, TX (US)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/165,908

(22) Filed: Jun. 10, 2002

(51) Int. Cl. H04B 17/02; H04B 1/06; H04B 7/00; H04B 1/10

(52) U.S. Cl. 455/139; 455/296; 455/278.1

(57) ABSTRACT

A system and method for combining the downlink signals from at least two transceivers to increase the power of the downlink signal. In-phase down link signals from at least two transceivers are combined to produce a downlink output signal having an output power level greater than the power level of any single downlink signal. Detector means, which samples the downlink signals to identify a phase difference is coupled to control a phase controller which adjusts the phase of at least one of the downlink signals to be in step with the phase of the other downlink signal. The phase controller maintains the downlink signals in phase by shifting the phase of at least one of the downlink signals relative to the other.

### FIELD OF THE INVENTION

This invention relates generally to wireless transceivers, and more particularly to a method and system for increasing transmitter output power of a wireless signal.

### BACKGROUND OF THE INVENTION

Cellular providers are in the process of changing or have completely changed their systems from analog to digital. This change to digital allows the cellular providers to provide more capacity, reduce costs and provide more services.

One digital cellular system is the next generation GSM/EDGE system. The evolved system offers many advantages and features that are not available to a user of the current system, be it analog or digital. One advantage is that data can be transmitted and received at a much higher data rate. Because the new system operates at a higher rate, higher power is required at the mobile terminal in order to obtain comparable coverage as a older generation systems. This requirement means that there must be a corresponding higher power output at the base station. Therefore, to implement a next generation system, it may be necessary for the service provider to transmit information from the base station at increased power levels. The output power of the signal from the base station has a direct impact on, and determines the maximum size of, the cell that the base station can support and hence the coverage area that can be provided by the base station.

As 3G wireless systems start to be introduced commercially, output power is going to be even more critical as these higher data rate systems require higher power at the mobile receiver to achieve optimum data throughput rates, in part, because the link may not necessarily be balanced for systems such as (E)GPRS since it may be downlink limited. In addition, operators are going to want to maintain the same cell sizes as they have in their currently installed systems. As a result, there is going to be a need for higher output power from base station transmitters.

Traditionally, separate booster amplifiers have been used to increase the output power of a base station to enhance the downlink coverage. Booster amplifiers are added after the transmitter and power amplifier in a normal transmitter chain unit. While such an arrangement provides the required output power, several disadvantages result from such a design. Additional booster amplifier units have to be located in the base station cabinet. Because the booster units operate at very high RF powers, they are less reliable. Finally, if a booster amplifier unit fails, service on that frequency is lost. Since the booster amplifier unit works at higher power levels, bypassing the failed booster unit is very difficult.

PCT Patent Publication No. WO 00/64072 discloses a method and apparatus for improving the radio link budget of cellular based stations. From the same base station, in-phase downlink signals that have the same frequency are combined to produce an output signal having increased power. The downlink signals are fed to a combiner which provides an output signal at a power level that is greater than the power level of any one of the in-phase down link signals. To insure that the signals from the channel units are always in phase and always at the same frequency, the channel units get their frequency reference from a common source. A phase control provides correction for phase differences caused by different lengths of cables which connect the channel units to the power combiner.

U.S. Pat. No. 5,886,573 discloses a device for high power linear amplification of an amplitude and/or phase modulated signal using multiple amplifiers driven by an appropriate set of switched and/or phase modulated constant amplitude signals derived from the input signal.

### SUMMARY OF THE INVENTION

The present invention provides a method and apparatus for improving the radio link between a cellular base station and a mobile terminal. In-phase down link signals from at least two transceivers of a base station are combined to produce a downlink output signal having an output power level greater than the power level of any single downlink signal.

A power combiner combines the downlink signal from two or more transceivers where the downlink signals are at the same frequency and each has a predetermined power level. Detector means, which constantly samples the downlink signals to identify a phase difference, or samples the signal from the combiner, is coupled to control a phase controller which adjusts the phase of at least one of the downlink signals to be in phase with the other downlink signals. The phase controller maintains the downlink signals in phase by shifting the phase of at least one of the downlink signals relative to the other. Because one or more of the downlink signals are shifted, if necessary, to be in phase with other downlink signals, the signals may be combined constructively to provide a single, higher output power signal that can provide greater base station range and therefore greater coverage area.

The present invention is an intelligent, closed loop feedback, power combining system which requires minimal modifications to a standard base station installation. Because the system minimizes the power consumption of the power booster, there is no requirement for high power consumption power boosters with their associated higher capital, service and operating costs. The reduced power consumption of the system should also provide an improvement in reliability. Additionally, only one antenna is required, although multiple antennae can also be used.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 is a block diagram of structure for coupling transceiver equipment located within two transceivers;

FIG. 2 is a simplified block diagram of downlink related elements of a transmitter unit of a base transceiver station;

FIG. 3 is a block diagram of an embodiment of a base transceiver station of the present invention where downlink signals from two transceivers are combined to increase the output power level of the downlink signal from one transceiver;

FIG. 4 is a block diagram of an embodiment of a base transceiver station of the present invention where downlink signals from three transceivers are combined to increase the output power level of the downlink signal from one transceiver;

FIG. 5 is a block diagram of an embodiment of a base transceiver station of the present invention where downlink signals from four transceivers are combined to increase the output power level of the downlink signal from one transceiver;

FIG. 6 is a block diagram of an embodiment of the power combiner of the present invention;

FIG. 7 is a block diagram of another embodiment of the power combiner of the present invention; and

FIG. 8 is a block diagram of still another embodiment of the power combiner of the present invention.

### DETAILED DESCRIPTION OF THE PRESENTLY PREFERRED EMBODIMENTS

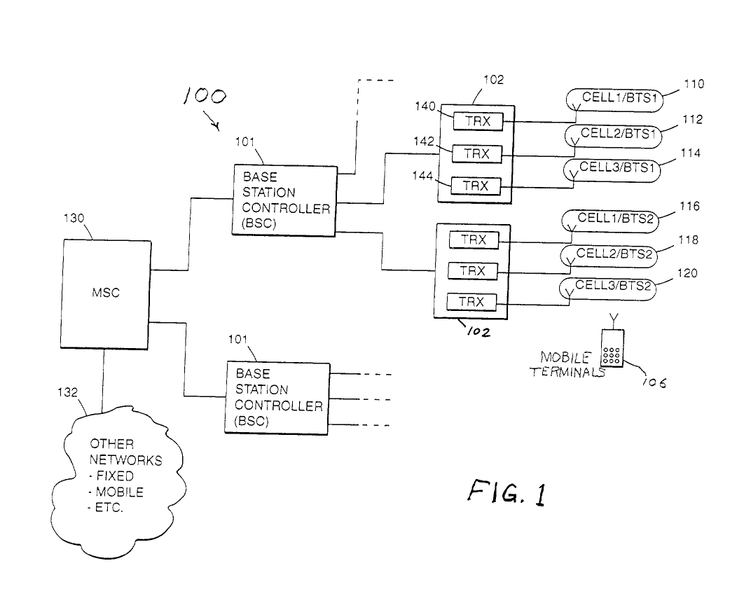

FIG. 1 illustrates a mobile communication system 100 in accordance with an embodiment of the present invention. The system 100 comprises a plurality of base stations 102 connected to base station controllers 101, and a plurality of mobile terminals 106. The service area of the mobile communication system 100 for each base station 102 is divided into a plurality of cells 110, 112, 113, 116, 118, 120. The mobile switching center (MSC) 130 is connected with another mobile communication system or fixed network 132 and coordinates the setting up of calls to mobile terminals 106. The mobile terminals 106 can move within a service area which is formed by the plurality of base stations 102 for communication through a channel allocated to a base station 102.

The base stations 102 are network elements that interface the mobile terminal 106 to the network via the air interface. The primary function of the base stations 102 is to maintain the air interface, or medium, for communication to any mobile terminal within its cell. Other functions of the base stations 102 are call processing, signaling, maintenance, and diagnostics. The base stations 102 each include transceivers 140, 142, 144. The transceivers 140, 142, 144, which represent at least one receiver and one transmitter, provide coverage to the cells 110, 112, 114 covered by the respective base station 102. The transceivers 140, 142, 144 also receive calling signals sent from the mobile terminal 106 while they are located within a corresponding cell, and detect up-link carrier wave power of the received signal.

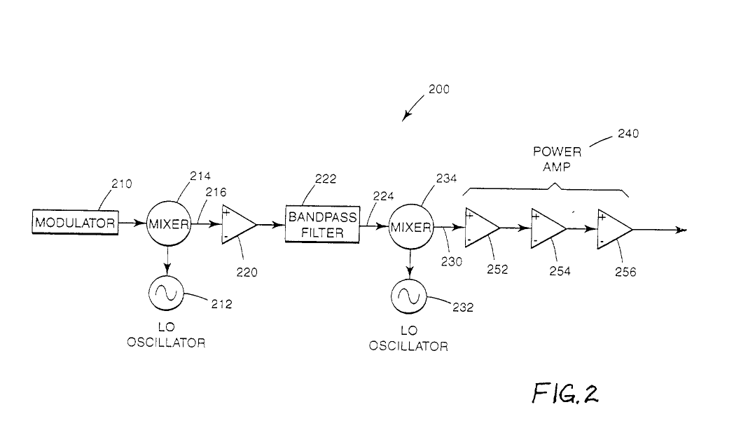

FIG. 2 illustrates a simplified block diagram of a transmitter unit 200. A modulator 210 modulates a signal which is then upconverted using a first local oscillator 212 and mixer 214. The upconverted signal 216 is then amplified by amplifier 220 and filtered by band pass filter 222. The filtered signal 224 is then upconverted using a second local oscillator 232 and mixer 234 to the desired frequency to produce a radio frequency (RF) signal 230. The RF signal 230 is then passed through a power amplifier stage 240 that includes, for example, high power amplifiers 252, 254, 256. To provide the required RF output power from the transmitter unit 200, a booster unit may be provided after the last amplifier 256. The booster unit includes a booster amplifier which is a high output-power amplifier.

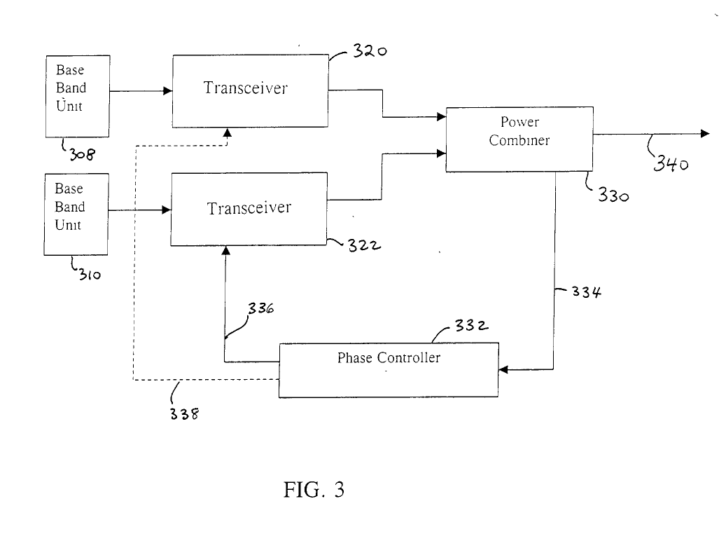

FIG. 3 illustrates a transceiver downlink portion according to the present invention for constructively (i.e., in-phase) combining the RF output signals from two transceivers to provide a single, higher output power signal that can effectively increase the range (the area of coverage) of a base station. A first transceiver has a base band unit 308 which provides a signal to a transceiver 320. A second transceiver has a base band unit 310 which provides a signal to a transceiver 322. One or both of units 308 and 310 may alternatively control base band units. The output of transceivers 320, 322 are provided to a power combiner 330 to provide an output signal 340. The power combiner 330 combines two RF output signals from the transceivers 320, 322 from two different transceivers. The phase of at least one of the two RF signals from the two transceivers 320, 322 is controlled to be in phase with the other signal. A phase controller 332 is coupled to receive a function signal 334 from the power combiner 330. The function signal 334 is a sampling of the phase relation of the signal from one transceiver 320 relative to the phase of the other transceiver 322, or a sampling of the RF power of the output signal 340. The output signal 336 of the phase controller 332 is directed to one or both of the transceivers 320, 322 to adjust the phase of the RF signals of the two transceivers 320, 322 so that they are in phase so that the RF signals will combine constructively. Adjustment of the phase of the RF signal of only one of the transceivers 320, 322 will obtain a match of the phase of the RF signals of the two transceivers. Alternatively, the RF signals of both of the transceivers 320, 322 may be adjusted. In operation, phase controller 332 adjusts the phase of the RF signal of transceiver 322 by means of phase adjustment signal 336 until the RF signal 340 from the power combiner 330 is at a maximum value as determined by the function signal 334. If the RF signal of the other transceiver 320 is also to be adjusted, a second phase adjustment signal 338 (shown as a dashed line) is transmitted from the phase controller 332 to transceiver 320.

The system is a closed loop feedback system that continuously samples the phase of the output signals from the transceivers 320, 322 of the different transceivers, or the signals after they are combined to provide a function signal 334 that is directed to a phase controller 332 which generates a phase adjustment signal 336, 338 to adjust the phase of the RF signal of one or more of the transceivers 320, 322 to provide a signal 340 which has maximum output power at the output of the power combiner.

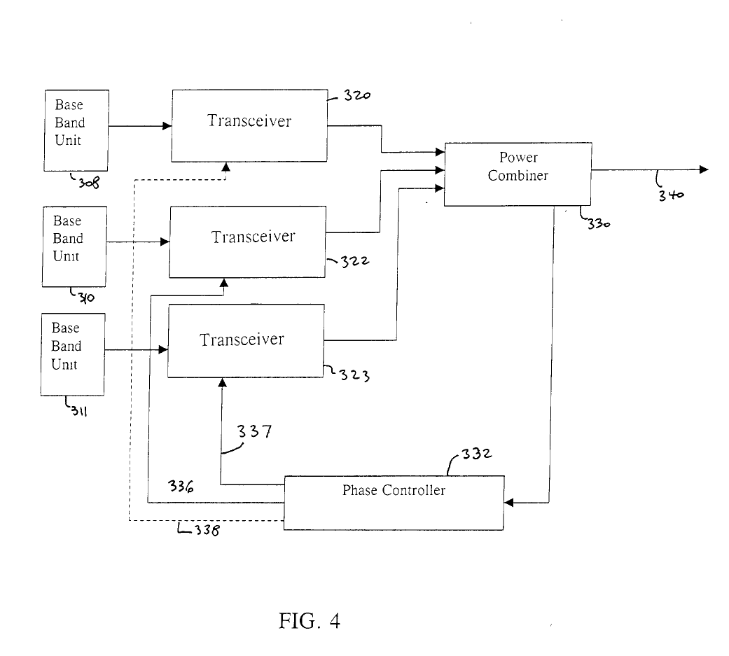

FIG. 4 shows a transceiver downlink portion according to the present invention in which the RF signals of three transceivers 320, 322, 323 are combined by power combiner 330. This embodiment is identical to that shown in FIG. 3 except for the additional transceiver 323 and its associated base band unit 311, which may be a control base band unit. Similarly, the phase of the RF signal output by transceiver 323 is adjusted by a signal 337 generated by the phase controller 332. Additional transceivers can be added in a similar fashion.

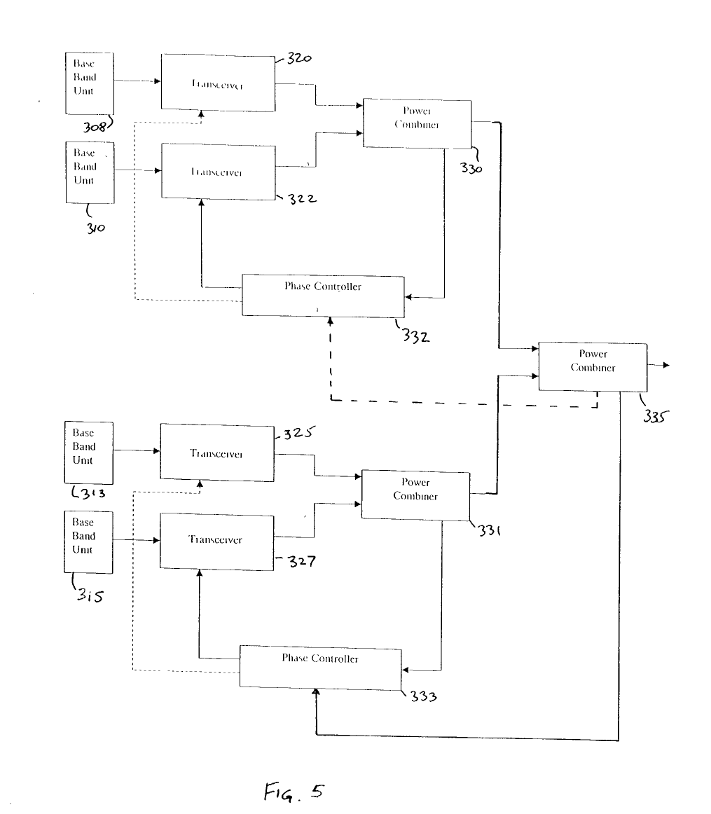

FIG. 5 shows a transceiver downlink portion according to the present invention in which the RF signals of four transceivers 320, 322, 325, 327 (and their respective base band (or control base band) units 308, 310, 313, 315) are combined by power combiner 335. In this embodiment, two transceiver downlink portions as shown in FIG. 3 are combined in parallel, with the outputs of their respective power combiners 330, 331 being combined by power combiner 335. The phase controller 330, 331 of each transceiver downlink portion is controlled by a signal from its respective power combiner 330, 331, respectively, and by a signal from power combiner 335. Although in FIG. 5, only two transceivers are shown for each parallel path, i.e., the signals from transceivers 320, 322 being fed to power combiner 330, alternatively, each parallel path may have more than two transceivers, as is shown in FIG. 4. In addition, although only two parallel transceiver paths with respective power combiners 330, 331 feeding their signals to power combiner 335 are shown in FIG. 5, alternatively, there may be more than two parallel paths, with each path feeding its signal to power combiner 335 and their respective phase controller 33 being controlled by a signal from power combiner 335. Additionally, one of the parallel paths for which the signal is fed to power combiner 335 may comprise only a single base band unit and a single transceiver.

As discussed above, the phase adjusting signal(s) 336, 337, 338 from the phase controller(s) 332, 333 is used to control the phase of the RF signals from the transceivers so that the RF signals are substantially in phase. Such phase adjustment can be accomplished in at least three ways. In an initial carrier phase method, for each RF signal burst, the initial phase of the RF carrier is adjusted by loading the appropriate initial phase into the base band oscillator. In an initial modulation phase method, for each RF signal burst, the initial phase of the modulation is adjusted by using a fixed initial phase on the base band oscillator. In a reference clock phase method, the phase of the transceiver reference clock is adjusted.

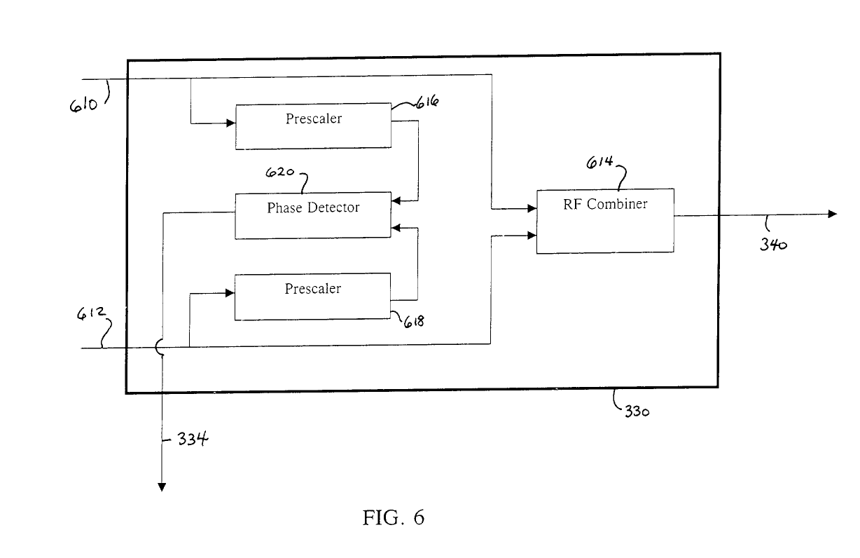

FIG. 6 is a block diagram of a phase detector embodiment of the power combiner 330 of the present invention where the phase relationship between the two RF signals is used to obtain the function signal (e.g., signal 334 in FIG. 3). The RF signal 610 from a first transceiver is directed to an input terminal of RF combiner 614 and sampled by prescaler 616. The RF signal 612 from a different transceiver is directed to a second input terminal of RF combiner 614 and is sampled by prescaler 618. The RF signals 610, 612 have the same frequency. In RF combiner 614, the signals input thereto are combined or added to one another to generate output signal 340. A phase detector 620 receives the output signals from prescalers 616, 618. The prescalers 616, 618 are used to frequency divide the input signals 610, 612 so that they are at a frequency that can be processed by phase detector 620. Phase detector 620 compares the two signals 610, 612 to determine how one or both of the input signals must be modified to be substantially in phase with the other. The output signal of phase detector 620 is the function signal 334 which provides the appropriate function to modify the phase of the appropriate input signals 610, 612. The function signal 334 is directed to a phase controller (e.g., phase controller 332 in FIG. 3), the output of which is fed to one or more of the transceivers to appropriately adjust the phase of the RF signal from that transceiver to be similar to the phase of the RF signal from the other transceiver.

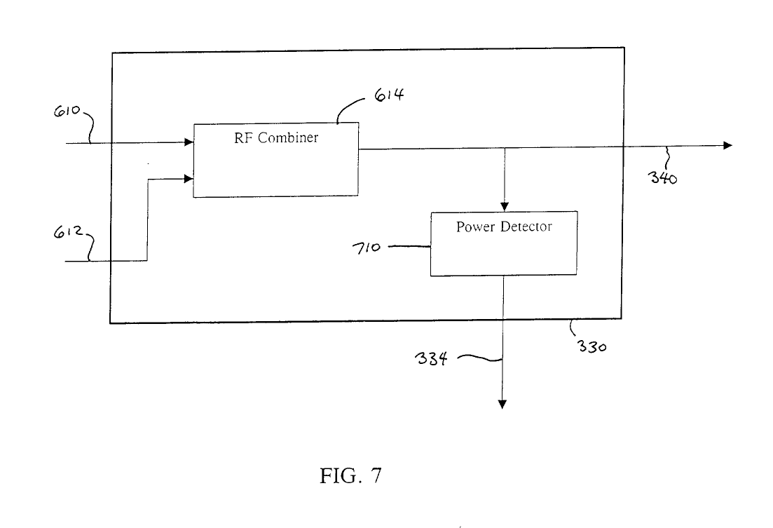

In the embodiment of the present invention shown in FIG. 7, a power combiner 330 is shown in which the combined RF signals from the transceivers output from the RF combiner 614 is sampled and used to adjust the transceiver outputs. The RF signal 610 from a first transceiver is fed to an input terminal of RF combiner 614, and the RF signal 612 from a different transceiver is fed to a second input terminal of the RF combiner 614. The output signal 340 of the RF combiner 614 is sampled by power detector 710 which generates a function signal 334, the value of which represents the power level of the signal from the RF combiner 614. The RF power detector 416 samples the composite output signal 340 to determine when the output power is the highest, indicating that the input transceiver signals 610, 612 are substantially in phase.

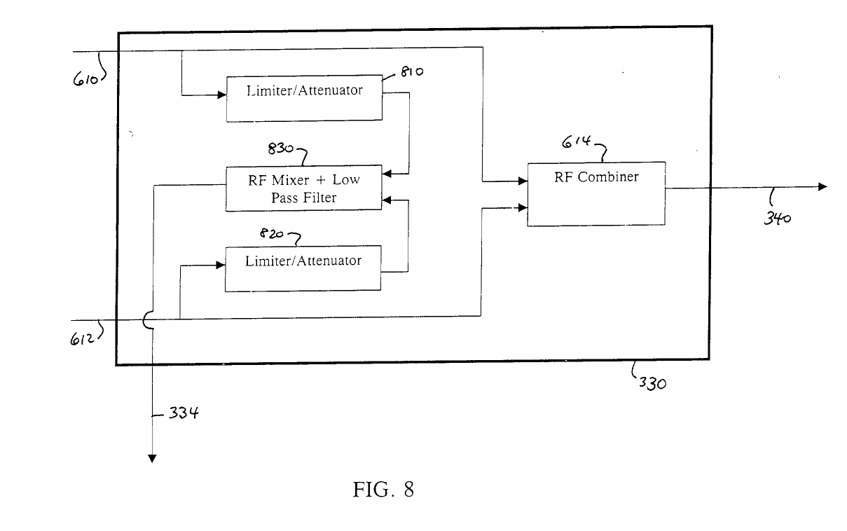

FIG. 8 shows another embodiment of the present invention in which an RF mixer is used to obtain a function signal 334, the value of which is determined by the phase difference between the two RF signals from different transceivers. The RF signal 610 from a first transceiver is fed to an input terminal of RF combiner 614 and is sampled by limiter/attenuator 810. The RF signal 612 from a different transceiver is directed to a second input terminal of RF combiner 614 and is sampled by limiter/attenuator 820. The RF signals 610, 612 have substantially the same frequency. RF mixer and low pass filter 830 receives the outputs from limiter/attenuators 810, 820. The output signal of RF mixer 830 is the function signal 334 which is fed to the phase controller 332 to control the phase of at least one of the transceivers. The embodiment of FIG. 8 is similar to the embodiment of FIG. 6 in that it measures the phase difference between the two RF signals from two transceivers of two different transceivers. However, in this embodiment, an RF mixer is used to obtain the phase difference. A sample of each of the RF signals is passed through an RF limiter to remove substantially all amplitude modulation (AM) of the signal that is present. AM is removed because it can create an error in the phase detection process. It does not have to be completely removed, only reduced below an acceptable limit. AM can be removed by using a limiter which clips the level of the signal to a predetermined value which is independent of the input level to remove the AM on the signal. It does this in a controlled manner and does not add a significant amount of phase modulation (i.e., phase error) in the process. Overdriving or saturating the mixers will result in nonlinear operation of the mixer. To prevent this, attenuators are used. If the level of the input signal to the mixer is low, the mixer acts as a simple multiplier. When mixing (multiplying) two sinusoidal signals in unit 830, the outputs are the sum and difference frequencies. The low pass filter removes the sum (2×frequency) and passes the low frequency component, the difference frequency.

Thus, while there have been shown and described and pointed out fundamental novel features of the present invention as applied to a preferred embodiment thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A system for combining downlink signals from a plurality of transceivers comprising:
a plurality of transceivers, each simultaneously transmitting a downlink signal of substantially the same frequency;
a signal combiner coupled to receive the downlink signals from the plurality of transceivers and to combine the received signals into an output signal;
a plurality of signal adjusting means receiving the downlink signals from the plurality of transceivers for individually adjusting the downlink signals of the plurality of transceivers;
a signal analyzer receiving and analyzing each of the downlink signals output from the plurality of signal adjusting means to determine whether any of the downlink signals are not substantially in phase with other downlink signals, and, if said signal analyzer determines that any downlink signal is not substantially in phase with other downlink signals, generating a function signal sufficient to identify phase adjustment required by said transceivers to transmit the downlink signals substantially in phase with one another; and
a phase controller receiving the function signal and, in response thereto, generating a phase adjustment signal and transmitting the phase adjustment signal to at least one of the plurality of transceivers, the phase adjustment signal being sufficient to identify phase adjustment required by said transceivers to transmit the downlink signals substantially in phase with one another.

2. The system of claim 1, wherein said signal adjusting means comprises a prescaler for adjusting a frequency of each of the downlink signals received from the transceivers.

3. The system of claim 1, wherein said signal adjusting means comprises at least one of a limiter and an attenuator for sampling the downlink signal received from a transceiver and for substantially removing amplitude modulation from each of the downlink signals received from the transceivers.

4. The system of claim 1, wherein said signal analyzer comprises an RF mixer for receiving the downlink signals output from the plurality of signal adjusting means, and a low pass filter for filtering an output of the RF mixer.

5. The system of claim 3, wherein said signal analyzer comprises an RF mixer for receiving the downlink signals output from the plurality of signal adjusting means, and a low pass filter for filtering an output of the RF mixer.

6. The system of claim 1, comprising a plurality of signal combiners, a plurality of signal analyzers, and a plurality of phase controllers connected in parallel, and further comprising a total power combiner coupled to receive the output signals from said plurality of signal combiners, said total power combiner comprising:
a final signal combining means for combining the output signals received from said plurality of signal combiners into a total output signal;
a final signal analyzer receiving and analyzing each of the output signals received from said plurality of signal combiners to determine whether any of the output signals received from said plurality of signal combiners are not substantially in phase with other output signals, and, if said final signal analyzer determines that any of the output signals received from said plurality of signal combiners is not substantially in phase with other output signals, generating a function signal and transmitting the function signal to said phase controllers, the function signal transmitted by said final signal analyzer being sufficient to identify phase adjustment required by said transceivers coupled to said respective signal combiners to transmit the output signals substantially in phase with one another.

7. The system of claim 2, comprising a plurality of signal combiners, a plurality of signal analyzers, and a plurality of phase controllers connected in parallel, and further comprising a total power combiner coupled to receive the output signals from said plurality of signal combiners, said total power combiner comprising:
a final signal combining means for combining the output signals received from said plurality of signal combiners into a total output signal;
a final signal analyzer receiving and analyzing each of the output signals received from said plurality of signal combiners to determine whether any of the output signals received from said plurality of signal combiners are not substantially in phase with other output signals, and, if said final signal analyzer determines that any of the output signals received from said plurality of signal combiners is not substantially in phase with other output signals, generating a function signal and transmitting the function signal to said phase controllers, the function signal transmitted by said final signal analyzer being sufficient to identify phase adjustment required by said transceivers coupled to said respective signal combiners to transmit the output signals substantially in phase with one another.

8. The system of claim 5, comprising a plurality of signal combiners, a plurality of signal analyzers, and a plurality of phase controllers connected in parallel, and further comprising a total power combiner coupled to receive the output signals from said plurality of signal combiners, said total power combiner comprising:
a final signal combining means for combining the output signals received from said plurality of signal combiners into a total output signal;
a final signal analyzer receiving and analyzing each of the output signals received from said plurality of signal combiners to determine whether any of the output signals received from said plurality of signal combiners are not substantially in phase with other output signals, and, if said final signal analyzer determines that any of the output signals received from said plurality of signal combiners is not substantially in phase with other output signals, generating a function signal and transmitting the function signal to said phase controllers, the function signal transmitted by said final signal analyzer being sufficient to identify phase adjustment required by said transceivers coupled to said respective signal combiners to transmit the output signals substantially in phase with one another.

9. A method for combining downlink signals from a plurality of transceivers comprising:
simultaneously transmitting from a plurality of transceivers a downlink signal of substantially the same frequency;
receiving the downlink signals from the plurality of transceivers;
combining the received signals into an output signal;
individually adjusting the downlink signals of each of the plurality of transceivers;
analyzing each of the adjusted downlink signals to determine whether any of the downlink signals are not substantially in phase with other downlink signals;
if it is determined that any downlink signal is not substantially in phase with other downlink signals, generating a function signal sufficient to identify phase adjustment required by said transceivers to transmit the downlink signals substantially in phase with one another; and
transmitting in response to the function signal a phase adjustment signal to at least one of the plurality of transceivers sufficient to identify phase adjustment required by said transceivers to transmit the downlink signals substantially in phase with one another.

10. The method of claim 9, wherein said step of adjusting the downlink signals of each of the plurality of transceivers comprises adjusting a frequency of each of the downlink signals.

11. The method of claim 9, wherein said step of adjusting the downlink signals of each of the plurality of transceivers comprises substantially removing amplitude modulation from each of the downlink signals.

12. The method of claim 9, wherein said step of analyzing each of the adjusted downlink signals is performed by an RF mixer receiving the adjusted downlink signals, and further comprising filtering an output of the RF mixer with a low pass filter.

13. The method of claim 11, wherein said step of analyzing each of the adjusted downlink signals is performed by an RF mixer receiving the adjusted downlink signals, and further comprising filtering an output of the RF mixer with a low pass filter.
